(19) United States
(12) Patent Application Publication
(10) Pub. No.: US 2014/0145903 A1
(43) Pub. Date: May 29, 2014

(54) ANTENNA DEVICE

(71) Applicant: KABUSHIKI KAISHA TOKAI RIKA DENKI SEISAKUSHO, Aichi (JP)

(72) Inventors: Fumitaka YOSHIKAWA, Aichi (JP); Motoki NAKAGAWA, Aichi (JP)

(73) Assignee: KABUSHIKI KAISHA TOKAI RIKA DENKI SEISAKUSHO, Aichi (JP)

(21) Appl. No.: 14/065,957

(22) Filed: Oct. 29, 2013

(30) Foreign Application Priority Data
Nov. 27, 2012 (JP) 2012-258920

(51) Int. Cl. H01Q 7/06

(52) U.S. Cl. CPC H01Q 7/06
USPC 343/867

(57) ABSTRACT

An antenna device includes a core, a first bobbin, and a second bobbin. A first antenna coil is wound around the first bobbin. A second antenna coil is wound around the second bobbin. The second bobbin includes an accommodation portion, which includes an opening in an outer surface of the second bobbin at a location other than where the second antenna coil contacts. The accommodation portion accommodates the core, and the second bobbin is accommodated in the hollow interior of the first bobbin.

### CROSS-REFERENCE TO RELATED APPLICATIONS

This application is based upon and claims the benefit of priority from prior Japanese Patent Application No. 2012-258920, filed on Nov. 27, 2012, the entire contents of which are incorporated herein by reference.

### BACKGROUND OF THE INVENTION

The present invention relates to an antenna device that includes two antenna coils.

International Patent Application Publication No. WO2007/116623 describes an antenna device that includes two antenna coils. In addition to the two antenna coils, the antenna device includes two cores that intersect each other so as to form a cross. The two antenna coils are each wound around one of the two cores. This structure allows the antenna device to have directivity in the directions of two orthogonal axes.

When two antenna coils are respectively wound to two antenna coils like in the antenna coil device of International Patent Application Publication No. WO2007/116623, stress is applied to each core when winding the antenna coil to the core. This may crack or break the core. Such breakage of the core affects the antenna characteristics and is thus not preferable.

### SUMMARY OF THE INVENTION

One aspect of the present invention is an antenna device including a core, a first bobbin including a hollow interior, and a second bobbin. A first antenna coil is wound around the first bobbin. A second antenna coil is wound around the second bobbin. The second bobbin includes an accommodation portion. The accommodation portion includes an opening in an outer surface of the second bobbin at a location other than where the second antenna coil contacts. The accommodation portion accommodates the core, and the second bobbin is accommodated in the hollow interior of the first bobbin.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a perspective view of an antenna device according to one embodiment of the present invention;

FIG. 2 is an exploded perspective view of the antenna device shown in FIG. 1;

FIG. 3 is a front view of a first bobbin in the antenna device shown in FIG. 1;

FIG. 4 is a plan view of the first bobbin shown in FIG. 3;

FIG. 5 is a side view of the first bobbin shown in FIG. 3;

FIG. 6 is a front view of a second bobbin in the antenna device shown in FIG. 1;

FIG. 7 is a plan view of the second bobbin shown in FIG. 6;

FIG. 8 is a side view of the second bobbin shown in FIG. 6;

FIG. 9 is a cross-sectional view of an antenna device shown in FIG. 1;

FIG. 10 is a cross-sectional view of the antenna device taken along line X-X in FIG. 9;

FIGS. 11A and 11B are perspective views showing the assembling procedures of the antenna device;

FIGS. 12A and 12B are perspective views showing the assembling procedures of the antenna device; and

FIG. 13 is a cross-sectional view of an antenna device according to another embodiment of the present invention.

### DETAILED DESCRIPTION OF THE INVENTION

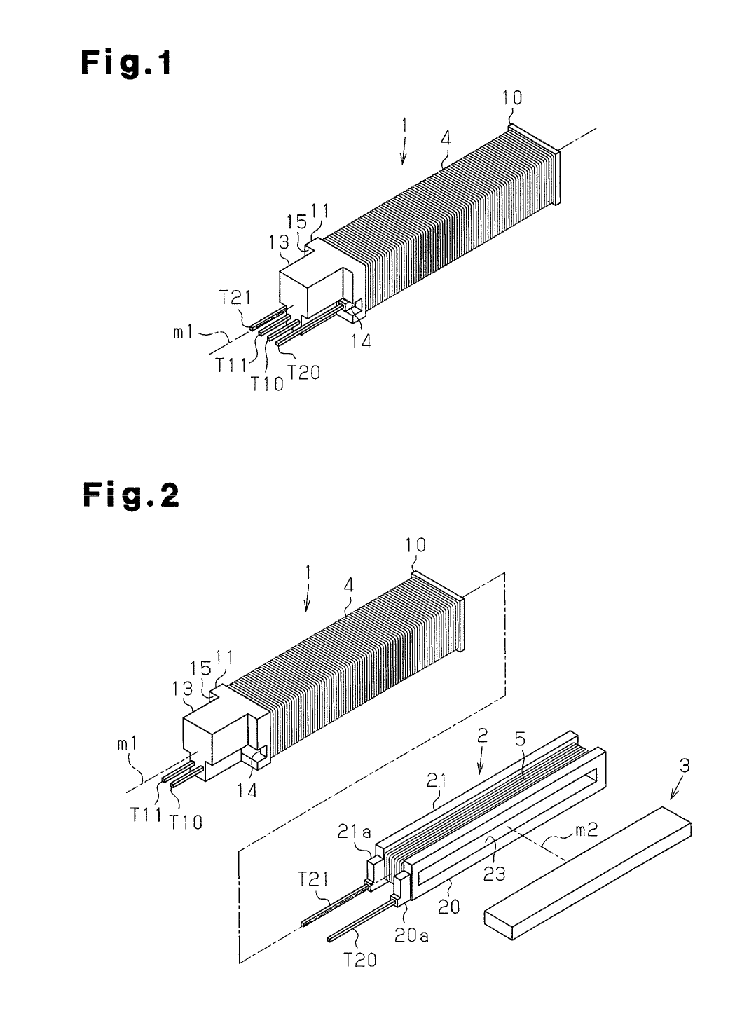

An antenna device according to one embodiment of the present invention will now be described with reference to FIGS. 1 to 12. The antenna device of the present invention is arranged in, for example, a handle of a vehicle door and used to transmit radio waves on a low frequency (LF) band to a region near the vehicle door.

Referring to FIGS. 1 and 2, the antenna device of the present embodiment includes a first bobbin 1 having a hollow interior, a second bobbin 2 accommodated in the hollow interior of the first bobbin 1, and a core 3 arranged in the second bobbin 2. In one example, the first bobbin 1 is box-shaped, the second bobbin 2 is parallelepiped, and the core 3 is planar. The bobbins 1 and 2 are each formed from a resin, and the core 3 is formed from a magnetic material such as ferrite. A first antenna coil 4 is wound around the first bobbin 1 about a center line (first axis m1) of the first bobbin 1. A second antenna coil 5 is wound about the second bobbin 2 about a second axis m2, which is orthogonal to the first axis m1. Thus, the antenna axes of the antenna coils 4 and 5 are orthogonal to each other. Due to the antenna coil 4 and 5, the antenna device of the present embodiment has directivity in the directions of two orthogonal axes.

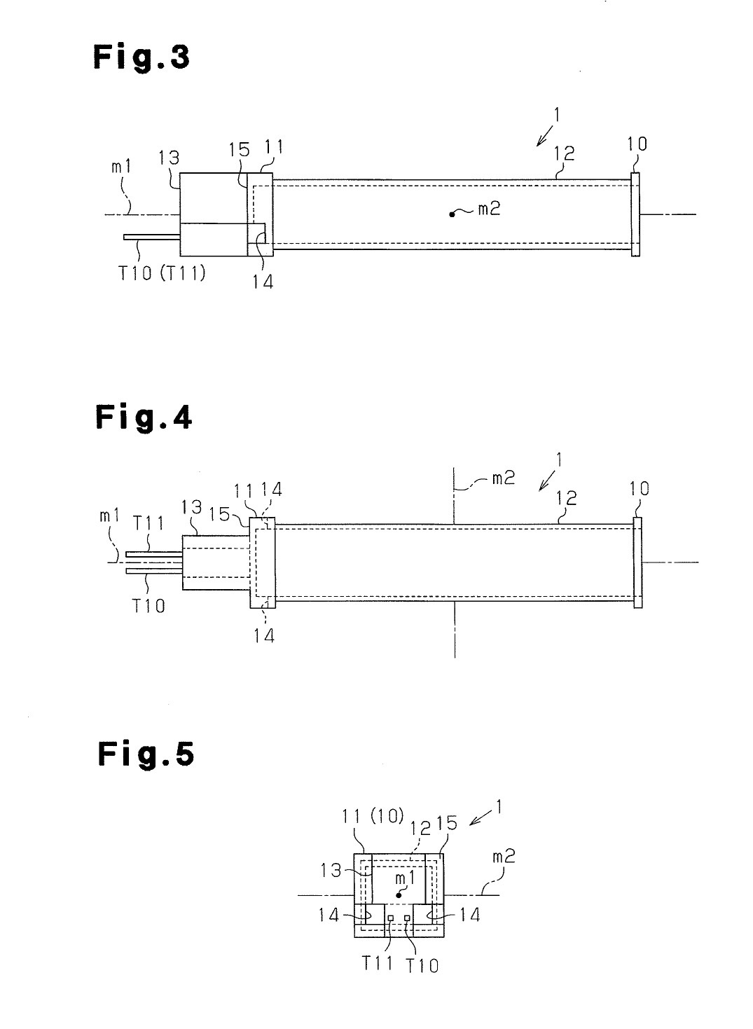

The structure of the first bobbin 1 will now be described in detail with reference to FIGS. 3 and 4.

The first bobbin 1 extends along the first axis m1 and includes flanges 10 and 11 located on its two ends. The first bobbin 1 includes a peripheral surface that defines a coil seat 12 around which the first antenna coil 4 is wound. The coil seat 12 extends between the flanges 10 and 11. The end of the first bobbin 1 proximal to the flange 10 is open, and the end of the first bobbin 1 proximal to the flange 11 is closed. Accordingly, the first bobbin 1 includes an end wall 15 proximal to the flange 11. The first bobbin 1 includes a connector 13 that extends from the outer surface of the end wall 15 in the direction of the first axis m1. The connector 13 is inserted into a connector arranged in a vehicle transmitter (not shown) to mechanically connect the transmitter and the antenna device. Two terminals T10 and T11 extend from an end surface of the connector 13 in the direction of the first axis m1. The terminals T10 and T11 are arranged parallel to each other. Wires (not shown) are arranged in the first bobbin 1 to electrically connect the terminals T10 and T11 to the two ends of the first antenna coil 4.

As shown in FIG. 5, the end wall 15 of the first bobbin 1 includes two through holes 14. The two through holes 14 extend through the end wall 15 from the outer surface of the end wall 15 into the hollow interior of the first bobbin 1. As shown in FIGS. 3 and 4, each of the two through holes 14 is in communication with a recess that extends from the through hole 14 to one side surface of the flange 11.

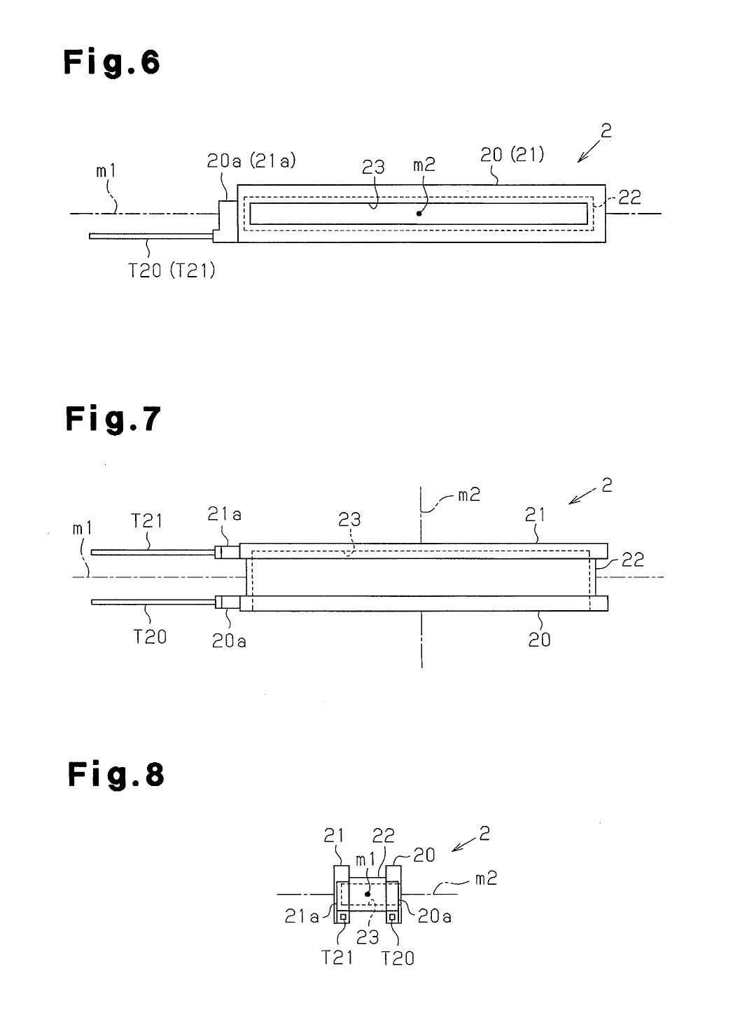

The structure of the second bobbin 2 will now be described with reference to FIGS. 6 to 8.

As shown in FIGS. 6 and 7, the second bobbin 2 includes flanges 20 and 21 located on two opposite sides. The second bobbin 2 includes a peripheral surface that defines a coil seat 22 around which the second antenna coil 5 is wound about the second axis m2. The flange 20 includes a projection 20a, which extends from one end of the flange 20 in the direction of the first axis m1. Further, the flange 21 includes a projection 21a, which extends from one end of the flange 21 in the direction of the first axis m1. The projection 20a includes a distal surface from which a terminal T20 extends in the direction of the first axis m1. The projection 21a includes a distal surface from which a terminal T21 extends in the direction of the first axis m1. The terminals T20 and T21 are arranged in parallel to each other. Wires (not shown) are arranged in the second bobbin 2 to connect the terminals T20 and T21 to the two ends of the second antenna coil 5.

Referring to FIG. 8, the interior of the second bobbin 2 defines an accommodation portion 23. The accommodation portion 23 has a recess-shaped cross-section in a direction orthogonal to the first axis m1. The accommodation portion 23 opens in the outer surface of the second bobbin 2 proximal to the flange 20. More specifically, the accommodation portion 23 includes an opening in an outer surface of the second bobbin 2 excluding the coil seat 22, that is, in the outer surface of the second bobbin 2 where the second antenna coil 5 does not contact. As shown in FIGS. 6 and 7, the accommodation portion 23 includes an opening, which is formed in the outer surface of the second bobbin 2 proximal to the flange 20, and a recess, which extends from the opening through the coil seat 22 and to the vicinity of the flange 21 in the second bobbin 2. The core 3 is accommodated in the accommodation portion 23.

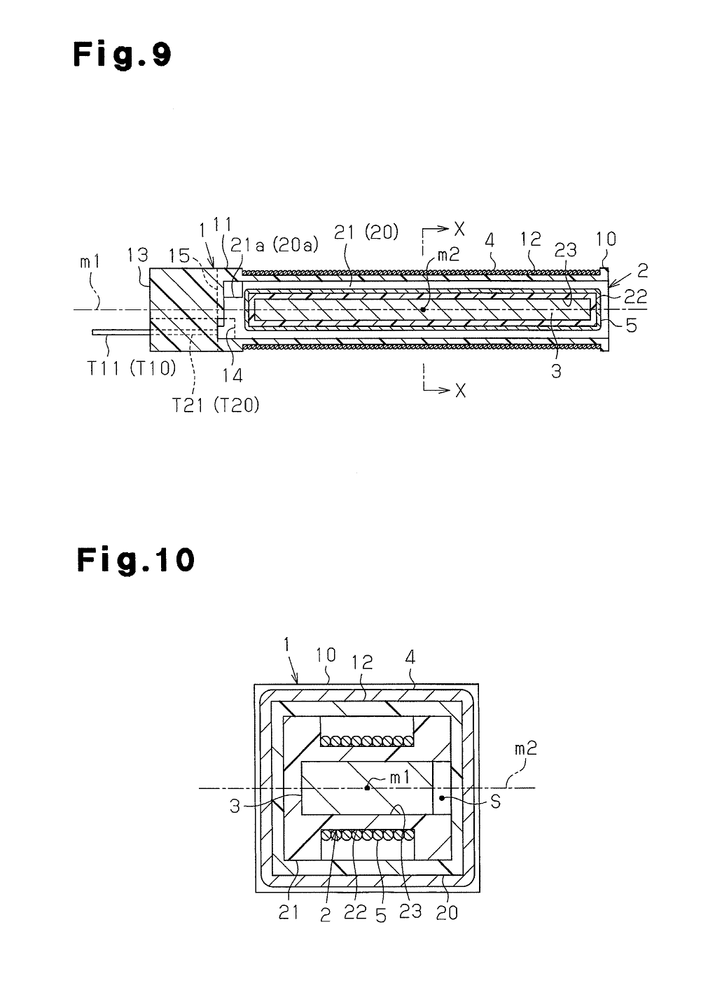

The second bobbin 2 is accommodated in the first bobbin 1 to form the antenna device. FIG. 9 shows the cross-sectional structure of the antenna device. Further, FIG. 10 shows the cross-sectional structure of the antenna device taken along line X-X in FIG. 9.

As shown in FIGS. 9 and 10, the second bobbin 2 is accommodated in hollow interior of the first bobbin 1. Here, the second antenna coil 5 is wound around the coil seat 22 of the second bobbin 2, and the core 3 is accommodated in the accommodation portion 23 of the second bobbin 2. Further, the terminals T20 and T21 of the second bobbin 2 are inserted through the two through holes 14 in the end wall 15 of the first bobbin 1 and exposed from the first bobbin 1 as shown in FIG. 1. This allows for the vehicle transmitter and the antenna device to be stably connected mechanically and electrically just by inserting the connector 13 of the first bobbin 1 in the connector of the vehicle transmitter (not shown).

As shown in FIG. 10, the outer wall surface of the second bobbin 2 is fitted to the inner wall surface of the first bobbin 1. This suppresses displacement of the second bobbin 2 relative to the first bobbin 1. Since relative displacement of the antenna coils 4 and 5 is suppressed, the desired antenna characteristics are easily ensured.

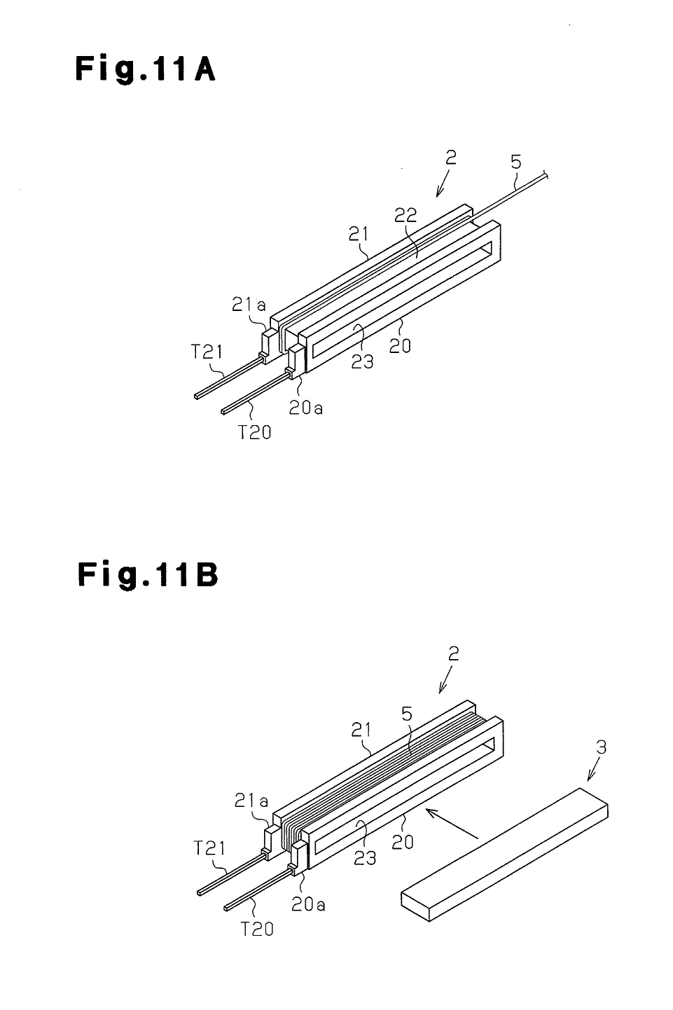

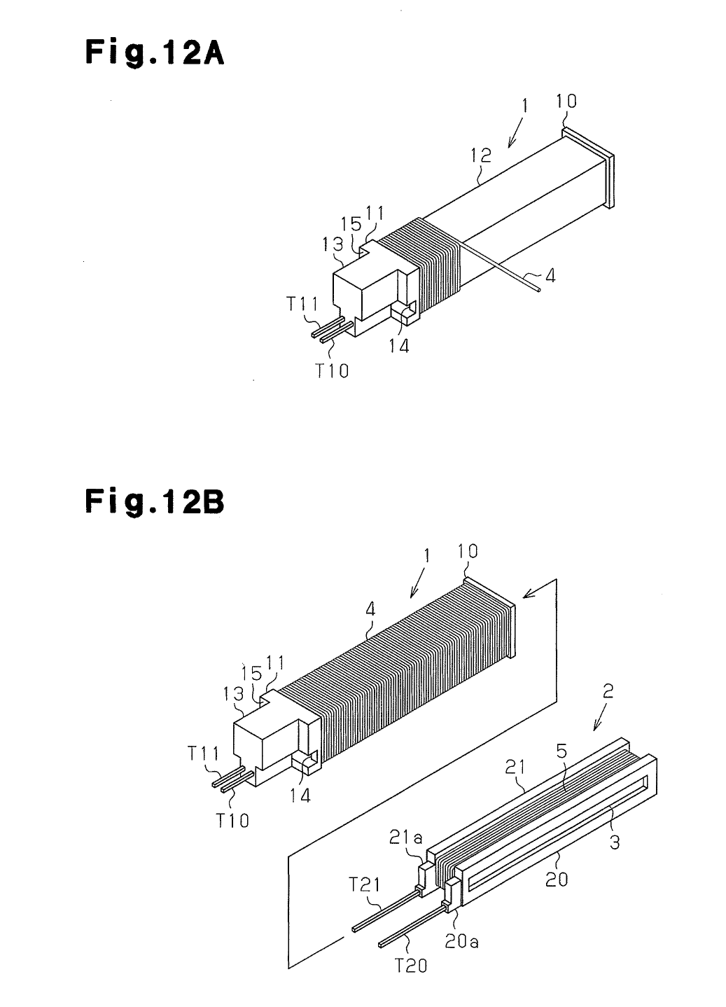

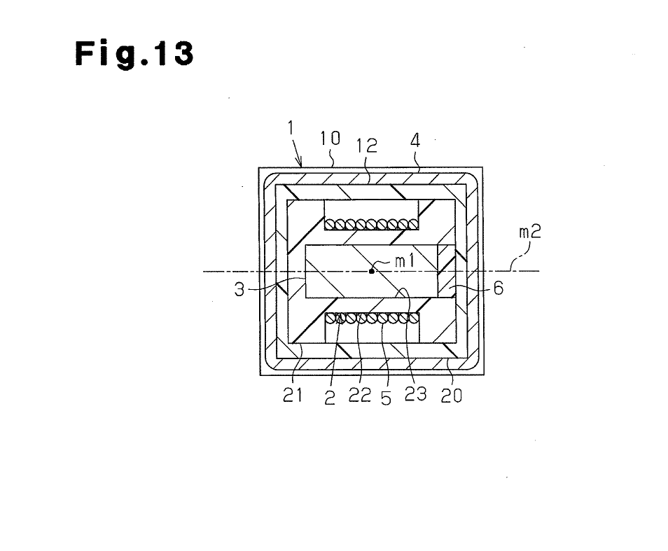

Referring to FIGS. 11 and 12, the process for assembling the antenna device of the present embodiment and the operation of the antenna device will now be described.

To assemble the antenna device of the present embodiment, as shown in FIG. 11A, the second antenna coil 5 is first wound around the coil seat 22 of the second bobbin 2. Then, as shown in FIG. 11B, the core 3 is accommodated in the accommodation portion 23 of the second bobbin 2. By coupling the core 3 to the second bobbin 2 in this manner, the stress produced when winding the second antenna coil 5 is applied to the second bobbin 2. This reduces the stress that acts on the core 3. Further, when the core 3 is accommodated in the accommodation portion 23 of the second bobbin 2, the core 3 comes into contact with the end wall of the accommodation portion 23, and the core 3 thus does not fall out of the second bobbin 2. This facilitates the coupling of the core 3 to the second bobbin 2.

Then, as shown in FIG. 12A, the first antenna coil 4 is wound around the coil seat 12 of the first bobbin 1. As shown in FIG. 12B, the second bobbin 2 is inserted into the hollow interior of the first bobbin 1, and the terminals T20 and T21 of the second bobbin 2 are inserted through the two insertion holes 14 in the end wall of the first bobbin 1. This completes the antenna device. By coupling the first bobbin 1 and the second bobbin 2 in this manner, the stress produced when winding the first antenna coil 4 acts on the first bobbin 1. This reduces the stress that acts on the core 3.

In this manner, in the antenna device of the present embodiment, the stress produced when winding the two antenna coils 4 and 5 is applied to the two bobbins 1 and 2. This obviates breakage of the core 3.

The antenna device of the present embodiment has the advantages described below.

(1) The antenna device includes the core 3, the first bobbin 1 around which the first antenna coil 4 is wound, and the second bobbin 2 around which the second antenna coil 5 is wound. The first bobbin 1 includes a hollow interior. The second bobbin 2 includes the accommodation portion 23, which opens in one outer surface of the second bobbin 2 at a location other than where the second antenna coil 5 contacts. Further, the accommodation portion 23 accommodates the first bobbin 1. Compared to when directly winding an antenna coil around the core 3, this reduces the stress applied to the core 3 and obviates damage of the core 3.

(2) The accommodation portion 23 is a recess that opens in the outer surface of the second bobbin 2 at a portion where the second antenna coil 5 does not contact. Thus, when coupling the core 3 to the second bobbin 2, the core 3 does not easily fall out of the second bobbin 2. This facilitates the coupling of the second bobbin 2 and the core 3. Further, when accommodating the second bobbin 2 in the first bobbin 1, the core 3 does not easily fall out of the second bobbin 2. This allows for the antenna device to be easily assembled.

(3) The first bobbin 1 includes an inner wall surface into which the outer wall surface of the second bobbin 2 is fitted. This suppresses relative displacement between the antenna coils 4 and 5 and easily ensures the antenna characteristics.

(4) The first bobbin 1 includes a hollow interior and the end wall 15. The first bobbin 1 includes the two terminals T10 and T11, which are arranged on the connector 13 of the end wall 15 and electrically connected to the two respective ends of the first antenna coil 4. The end wall 15 includes the two through holes 14 that extend to the hollow interior of the first bobbin 1. Further, the second bobbin 2 includes the two connection terminals T20 and T21 electrically connected to the two respective ends of the second antenna coil 5, and the ends T20 and T21 are inserted through the two through holes 14 of the first bobbin 1. This allows for the antenna device and the transmitter, which is arranged in the vehicle, to be electrically connected just by connecting the connector of the transmitter and the connector 13 of the first bobbin 1. Thus, the connection of the antenna device and the transmitter is facilitated.

It should be apparent to those skilled in the art that the present invention may be embodied in many other specific forms without departing from the spirit or scope of the invention. Particularly, it should be understood that the present invention may be embodied in the following forms.

As shown in FIG. 10, when a gap S is formed between the core 3 and the inner wall of the coil seat 12 in the first bobbin 1, the core 3 may be displaced. To obviate such displacement, a spacer 6 formed from, for example, a resin may be arranged in the gap S. This obviates displacement of the core 3 and ensures that the antenna characteristics are easily obtained.

In the above embodiment, the terminals T20 and T21 of the second bobbin 2 are inserted into the two insertion holes 14 in the end wall 15 of the first bobbin 1. Instead, for example, the terminals T20 and T21 of the second bobbin 2 may be exposed from the opening in the flange 10 of the first bobbin 1. In this case, there would be no need to form the through holes 14 in the end wall 15 of the first bobbin 1, and the structure of the first bobbin 1 may be simplified.

In the above embodiment, the accommodation portion 23 of the second bobbin 2 is recess-shaped but may have any form. For example, the accommodation portion 23 may extend through the second bobbin 2 from the outer surface of the side including the flange 20 to the outer surface of the opposite side including the flange 21.

In the above embodiment, the antenna device is assembled through the procedures exemplified in FIGS. 11 and 12. However, the procedures may be changed. For example, after accommodating the core 3 in the accommodation portion 23 of the second bobbin 2, the second antenna coil 5 may be wound around the coil seat 22 of the second bobbin 2. Further, after accommodating the second bobbin 2 in the hollow interior of the first bobbin 1, the first antenna coil 4 may be wound around the coil seat 12 of the first bobbin 1. Moreover, the first antenna coil 4 may be wound around the coil seat 12 of the first bobbin 1 before accommodating the core 3 in the accommodation portion 23 of the second bobbin 2 and winding the second antenna coil 5 to the coil seat 22 of the second bobbin 2. Regardless of the procedure, the stress produced when winding the two antenna coils 4 and 5 is applied to the two bobbins 1 and 2. This reduces the stress acting on the core 3 and obviates breakage of the core 3.

The bobbins 1 and 2 of the antenna device may be changed in form. For example, the first bobbin 1 may have the form of a hollow cylinder and the second bobbin 2 may have the form of a solid cylinder as long as the first bobbin 1 includes a hollow interior, the second antenna coil 5 is wound around the second bobbin 2, and the second bobbin 2 is accommodated in the hollow interior of the first bobbin 1.

In the above embodiment, the antenna axes of the two antenna coils 4 and 5 are orthogonal to each other. However, for example, the coil seats 12 and 22 of the bobbins 1 and 2 may be changed in form to change the directions of the antenna axes of the two antenna coils 4 and 5.

The above embodiment exemplifies a case in which the terminals T10, T11, T20, and T21 of the bobbins 1 and 2 are all connected to the transmitter. Instead, for example, just the terminals T10 and T11 of the first bobbin 1 may be connected to the transmitter. Alternatively, just the terminals T20 and T21 of the second bobbin 2 may be connected to the transmitter. This allows for the two antenna coils 4 and 5 to be independently driven.

The above embodiment is exemplified in a transmission antenna device arranged in the handle of a vehicle door. However, the antenna device may be arranged at a different location in a vehicle. The antenna device may also be arranged in a machine other than a vehicle. Further, the antenna device of the above embodiment may be used to receive signals.

The present examples and embodiments are to be considered as illustrative and not restrictive, and the invention is not to be limited to the details given herein, but may be modified within the scope and equivalence of the appended claims.

1. An antenna device comprising:
a core;
a first bobbin including a hollow interior, wherein a first antenna coil is wound around the first bobbin; and
a second bobbin around which a second antenna coil is wound, wherein
the second bobbin includes an accommodation portion,
the accommodation portion includes an opening in an outer surface of the second bobbin at a location other than where the second antenna coil contacts,
the accommodation portion accommodates the core, and
the second bobbin is accommodated in the hollow interior of the first bobbin.

2. The antenna device according to claim 1, wherein the accommodation portion is a recess that opens in the outer surface of the second bobbin at a location other than where the second antenna coil contacts.

3. The antenna device according to claim 1, wherein the first bobbin includes an inner wall surface that is fitted to an outer wall surface of the second bobbin.

4. The antenna device according to claim 1, wherein the first bobbin includes an end wall and two terminals arranged on the end wall,
the two terminals of the first bobbin are electrically connected to two ends of the first antenna coil, respectively,
the end wall includes two insertion holes extending through the end wall to the hollow interior of the first bobbin,
the second bobbin includes two terminals electrically connected to two ends of the second antenna coil, respectively, and
the two terminals of the second bobbin are inserted through the two through holes, respectively.

5. The antenna device according to claim 1, wherein
the first antenna coil is wound around the first bobbin about a first axis that is a center line of the first bobbin, and
the second antenna coil is wound around the second bobbin about a second axis that is orthogonal to the first axis.

6. The antenna device according to claim 3, further comprising a spacer that fills a gap between the inner wall surface of the first bobbin and the core.
